(19) United States
(12) Patent Application Publication
(10) Pub. No.: US 2007/0116460 A1
(43) Pub. Date: May 24, 2007

(54) Apparatus and method for adaptive adjustment and performance monitoring of avalanche photo-diode optical receiver and laser transmitter for fiber link long haul applications

(75) Inventors: Nikolai Fediakine, San Jose, CA (US); Shinkyo Kaku, San Jose, CA (US); Vitali Tikhonov, San Jose, CA (US)

Correspondence Address: ARENT FOX PLLC, 1050 CONNECTICUT AVENUE, N.W., SUITE 400, WASHINGTON, DC, 20036, US

(73) Assignee: Allied Telesis, Inc.

(21) Appl. No.: 11/522,517

(22) Filed: Sep. 18, 2006

Related U.S. Application Data
(60) Provisional application No. 60/717,193, filed on Sep. 16, 2005.

(51) Int. Cl. H04B 10/08

(52) U.S. Cl. 398/38

(57) ABSTRACT

A system and method for an Avalanche photo-diode (“APD”) optical receiver and laser system to adjust its performance during system operation without disturbing network traffic. Very small changes may be adaptively applied to some key portions of the system by controlling a set of main system parameters including Q-factor; Bit Error Rate (BER); histograms of “1” and “0” levels; input optical power; and laser output power. This adaptive routine may be performed during operation of the system to keep the main system parameters close to their optimum value. During adjustment, the system may be divided into separate portions. The adjustment of each portion may be independent of the other portions of the system. For the optical network system, optimization and priority of different portions may be assigned based on network channel architecture.

This application is based upon and claims the benefit of priority from the prior U.S. Provisional Application No. 60/717,193 filed on Sep. 16, 2005, the entire contents of which is incorporated herein by reference.

This application is related to and incorporates in its entirety, nonprovisional U.S. patent application entitled “Method and System for Control Loop Response Time Optimization,” filed on Sep. 18, 2006.

### BRIEF DESCRIPTION OF INVENTION

The present invention is generally directed to an Avalanche photo-diode (“APD”) optical receiver and laser system that can adjust its performance during system operation without disturbing network traffic. Specifically, the present invention is directed to adaptively applying small changes to key portions of the system by controlling a set of main system parameters. The adaptive routine may be performed during operation of the system to keep the main system parameters close to their optimum value. During adjustment, the system may be divided into separate system portions. The adjustment of each portion may be independent of the other portions of the system. For the optical network system, optimization and priority of the different portions may be assigned based on network channel architecture.

In particular, the present invention is directed to an apparatus and method for adaptive adjustment of parameters of different portions of an optical network system by using five controlled characteristics: Q-factor; Bit Error Rate (BER); histograms of “1” and “0” levels; input optical power; and laser output power. It will be recognized by those of ordinary skill in the art, however, that other key characteristics may also be used in conjunction with the apparatus and method of the present invention.

### BACKGROUND OF THE INVENTION

Real-time monitoring of an optical network system is important for controlling and improving the performance of the optical system. One known practice for real-time monitoring involves the use of a local memory, controllers, and look-up-table (LUT) circuits to adjust and to set the main system parameters. The main disadvantage of this method, however, is that this method requires a complicated initial calibration for the optical network channel before using the system.

Similar methods of self-adjustment (alternatively referred to herein as “adaptive adjustment”) are also used in practice to adjust the parameters of optical systems. In the system described in U.S. Pat. No. 5,929,982, for example, the adaptive adjustment of APD gain is achieved by adaptive optimization of the receiver signal-to-noise ratio. Specifically, for monitoring purposes, the noise level over some threshold is measured and is used for adaptive setting. However, a drawback of using an adaptive system to adjust the APD gain based on the measurement of noise over some threshold and calculating the signal to noise ratio is that, although this method may give adequate results when the received optical signal has a good quality with a clearly open eye diagram, when the quality of the eye diagram is not good, e.g., when there is optical dispersion in the fiber or there is insufficient signal time jitter, this method may not provide clear results and also may not allow for troubleshooting of faults in the signal link.

### SUMMARY OF INVENTION

There is a need in the art, therefore, for an apparatus and method for adaptive adjustment that does not require complicated initial calibration, while providing clear results and allowing for trouble-shooting of faults in the signal link. The present invention solves the above-identified needs, as well as others by providing an apparatus and method for adaptive adjustment of the parameters of different portions of the optical network system by using five controlled characteristics: Q-factor; BER; histograms of “1” and “0” levels; input optical power; and laser output power. These monitored parameters allow for comprehensive troubleshooting of different problems in an optical system operation because different portions of the optical system may be involved in an optical link fault. The use of the five parameters described above allows a user to determine and locate the portion of the system, e.g., the transmitter, the optical fiber, or the receiver, in which the fault occurred.

Other objects, features, and advantages will be apparent to persons of ordinary skill in the art from the following detailed description of the invention and the accompanying drawings.

### BRIEF DESCRIPTION OF THE FIGURES

For a more complete understanding of the present invention, the needs satisfied thereby, and the objects, features, and advantages thereof, reference is now made to the following description taken in connection with the accompanying drawings.

FIG. 1 shows a diagram of an optical network channel that may be used in conjunction with an embodiment of the present invention;

FIG. 2 shows an exemplary eye diagram and its relationship to the Q-factor, as used in conjunction with an embodiment of the present invention;

FIG. 3 shows a graph depicting the relationship of BER to the Q-factor value, in accordance with an embodiment of the present invention;

FIG. 4 shows a diagram of an eye diagram and corresponding histogram, as used in conjunction with an embodiment of the present invention;

FIG. 5 shows graph depicting the relationship of the APD Bias Voltage to temperature, as used in conjunction with an embodiment of the present invention;

FIG. 6 shows a diagram of an example with noise in one of the standard levels “1” or “0”;

FIG. 7 shows a graph comparing laser characteristics before and after equalizing according to an embodiment of the present invention;

FIG. 8 shows a graph comparing the system power budget before and after equalizing according to an embodiment of the present invention;

FIG. 9 shows an exemplary diagram of a task flow for a whole receiver system adaptive adjustment according to an embodiment of the present invention;

FIG. 10 shows an exemplary system diagram of various hardware components and other features, in accordance with an embodiment of the present invention.

### DETAILED DESCRIPTION

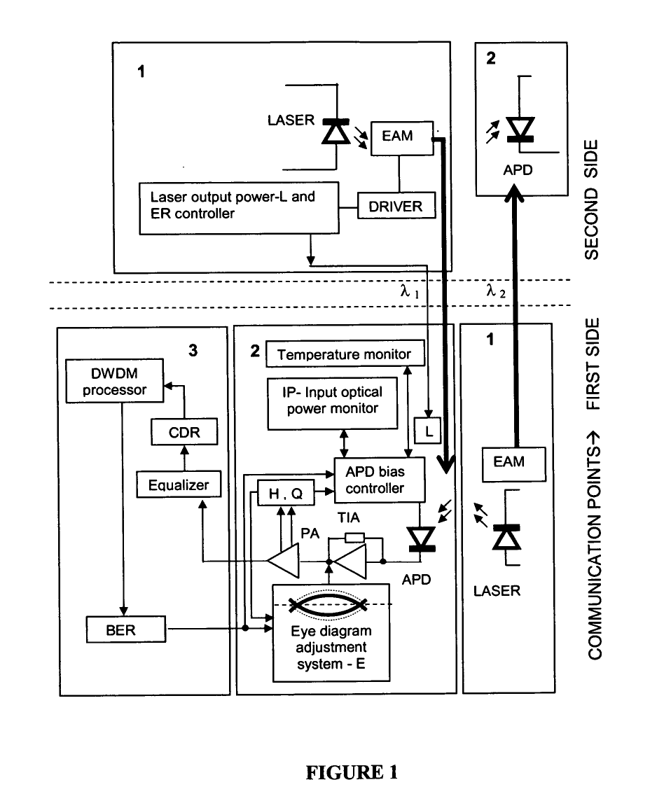

Referring now to FIG. 1, therein shown is the general architecture of an optical network channel, such as a Dense Wavelength Division Mutliplexer (DWDM) channel. Data traffic coming from the source to the destination is transmitted using a wavelength λ₁ across an optical fiber and is received by the APD receiver on the destination side of the optical fiber. An optical signal λ₂ is transmitted through the fiber to the transmitter side without interfering with the data traffic transported by λ₁. For the network system architecture, a set of system parameter-characteristics for adaptive system adjustment can include at least five parameters: Q-factor, represented by block Q; Bit Error Rate, represented by block BER; histograms of “1” and “0” levels, represented by block H; laser output power level, represented by block L; and measured input power level in the receiver, represented by block IP.

The use of these five parameters allows for an accurate adaptive adjustment of the receiver portion, after checking that the input signal coming into the receiver is within an appropriate range for performing precise adaptive adjustment.

In FIG. 1, blocks 1, 2, and 3 correspond to a Laser portion, an APD (Avalanche photo-diode) receiver portion, and a DWDM processor portion, respectively. The laser portion has a continuous wavelength laser that is modulated by an external modulator. A laser output power (block L in FIG. 1) is monitored and may be adjusted by a Laser output power controller. The APD receiver portion consists of the APD itself, an APD bias controller block, which maintains the optimal bias voltage at the APD; and Input power and Temperature monitors blocks. The APD receiver portion also has two amplifier stages: the trans-impedance amplifier (TIA) and post-amplifier (PA). The last portion in FIG. 1 is the DWDM processor portion. The block Equalizer in this portion is configured to compensate for signal optical dispersion that occurs when transferring optical signals along a long optical fiber.

Laser Output Power Level “L”

For the purpose of controlling attenuation in the fiber, the monitoring of laser output power level “L” is important in maintaining a desired performance of the system, particularly with respect to the receiver portion to ensure that the level of the input signal is sufficient to perform the adaptive adjustment for the receiver portion. The comparison of the value of the laser output signal (L) with the measured input optical power (IP) permits a determination as to whether a fiber is damaged. Moreover, using the whole set of system parameters and different portions (such as the receiver and the transmitter), gives flexibility and full set of monitoring features to control the whole network system without disturbing the traffic signals.

Q-Factor “Q”

Q factor is defined as:
Q=abs(μ₁−μ₀)/(σ₁+σ₀) [equation (1)]

where abs(μ₁−μ₀) denotes the separation between the intensity level of a “1” and a “0” of digital signals, and σ₁+σ₀ is the sum of the standard deviations of the intensities around levels “1” and “0”.

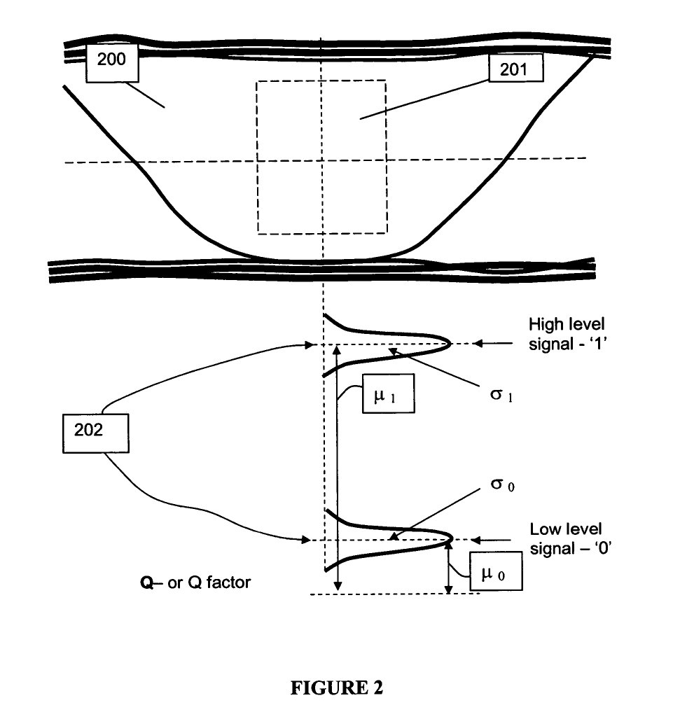

An example of the relationship between Q and the quality of an eye diagram is illustrated in FIG. 2. An eye diagram is one popular way to present the performance of a digital fiber-optics link by superposition of multiple pulses on the oscilloscope display. In FIG. 2, graph 200 represents the superposition of pulses to generate an eye diagram. The graph 201 shows the “eye” area, which is the area where there should be no interference between “1” and “0” levels. The all “1” pulses should be above the eye area, and the all “0” pulses should be below the eye area. This “eye” area (alternatively referred to herein as a mask) is the standard for different network protocols. The graph 202 represents the intensities of level “1” and level “0” in the center of the eye.

Relationship of Q-Factor to Bit Error Rate “BER”

Based on the Gaussian approximation for the noise distribution in the received signal, the following relationship between Bit Error Rate (BER) and Q as:
BER=½erfc(Q/sqrt(2)) [equation (2)]

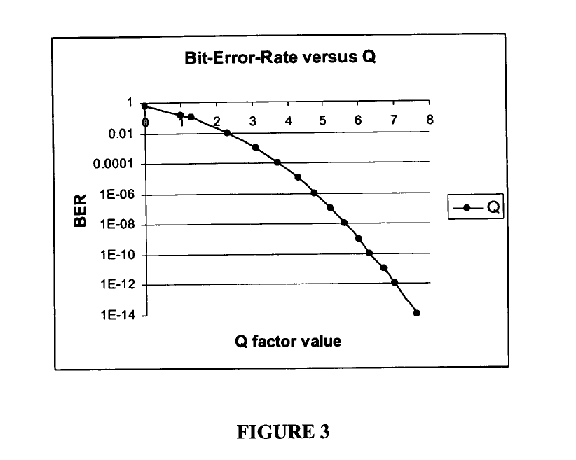

The calculated dependence of BER on the Q value is shown in FIG. 3. The direct relationship of BER to the Q value leads to the highest values of Q corresponding to the best BER reached by optical network channels. The only requirement for using equation (2) is that the signal distribution should be pure Gaussian. This provides the option of using only the Q factor for optimizing the system parameters. However, adjustment performed by using only the Q factor may not be precise if the signal distribution is sufficiently non-Gaussian, and the contribution of the other factors, such as optical dispersion and additional pick-up noise, may be taken into account by using other parameters, such as H and BER, to provide an exact solution.

Histograms of Intensities of Level 1 and Level 0 “H”

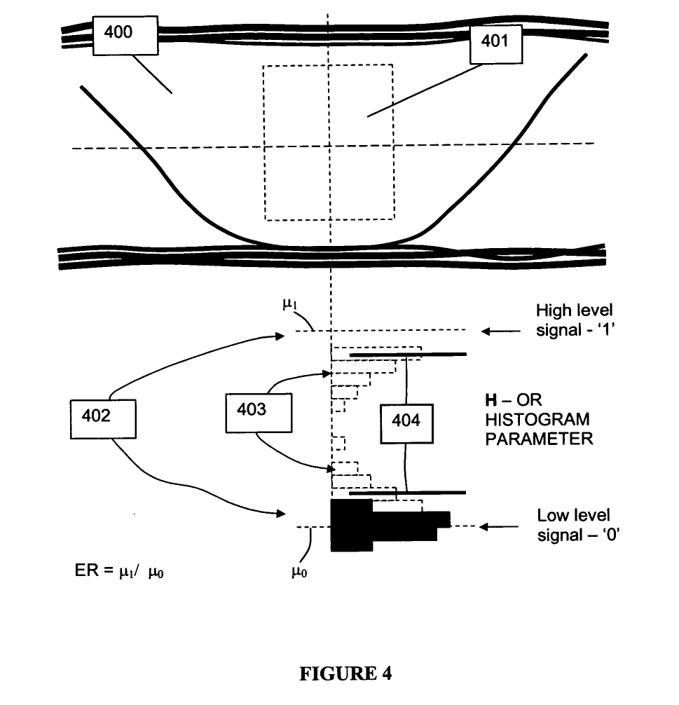

Another parameter that may be used for optimization is H, representing real histograms of intensities of level “1” and level “0.” The relationship between the signal eye diagram and H is shown in FIG. 4. In FIG. 4, the graph 400 represents a signal eye diagram. Graph 401 shows the “eye” area. The graph 401 shows the histograms of intensities of level “1” and level “0” in the case of a satisfactory link and a satisfactory eye diagram. In this case, the histogram of intensity of level “1” is in the area above the “eye” area (graph 404), and the intensity of the “0” level is in the area below the “eye” area. By using H, it is possible to work with eye diagrams in which both level intensities come into forbidden “eye” area. Graph 403 shows an example of histograms in this scenario. Cleaning of areas 401 and 404 may be the first priority task for adjusting the quality of the eye diagram by measuring histograms (or H, as described in connection with FIG. 1).

Input Power “IP”

The controlling of the input power (IP) block, shown in FIG. 1 and the laser extension ratio (ER) allows for a determination of whether the input signal is at a stage where adaptive adjustment may be performed. For example, in the embodiment shown in FIG. 4, ER is μ₁/μ₀.

The controlling of the input power IP simultaneously with the laser output power (block L in the FIG. 1) permits making a conclusion regarding the quality of the fiber itself or the laser, if laser output power was not set correctly. The relationship to determine the total losses into fiber is:
Insertion loss=IP/L [equation (3)]

According to another aspect of the present invention, by adaptively adjusting the system by monitoring the whole set of parameters (at least the five aforementioned parameters—Q, BER, H, IP, and L), the comprehensive adjustment of the optical receiver and the troubleshooting of different problems in the system may be accomplished.

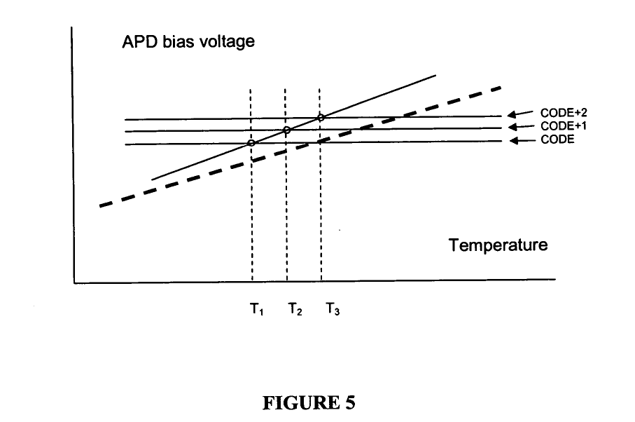

FIG. 5 shows how the adaptive circuit corrects APD bias voltage in accordance with an embodiment of the present invention by changing the setting in one bit (represented by the CODE value). The optimal value of APD bias for each temperature (T₁,T₂ and T₃ ) can be chosen by finding the maximum value of Q. An initial (dashed) curve may be used at the start of adaptive process. This represents a preliminary, rough temperature coefficient curve to be loaded in the memory of the system, after which the system itself can adjust bias voltage.

Referring to FIG. 5, the adjustment of the APD bias voltage by searching for the maximum value of Q as the main parameter (and in addition using the H, BER, IP, and L parameters when the quality of the eye is not sufficient) may also be used to maintain the APD bias voltage temperature compensation.

The APD bias voltage temperature compensation may performed by using a look-up-table. In this way, the linear dependence of the required bias voltage versus the temperature is loaded in the memory, and the system itself sets the bias voltage corresponding to the measured temperature. The main disadvantage of this method, however, is that this method requires a complicated initial calibration for the optical network channel before using the system.

One substantial advantage of using adaptive adjustment is that initially, only a preliminary, rough temperature coefficient curve needs to be loaded, and then the system itself can adjust bias voltage. An additional advantage of the apparatus and method according to the present invention is that when some of the parameters of the APD receiver are altered, the system itself can correct these changes without stopping operation.

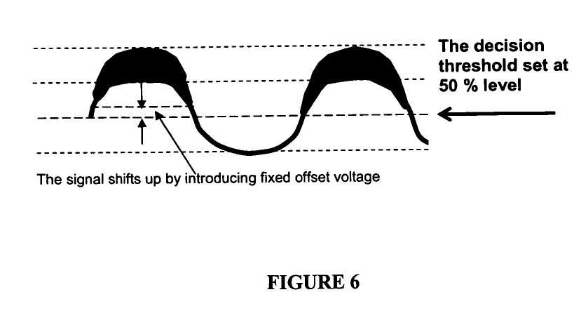

The decision threshold for the eye diagram may be adjusted by optimizing BER and, in addition, by optimizing H, Q, IP, and L. If one of the standard levels “1” or “0” is very noisy (see, e.g. FIG. 6), it is possible to set additional offset voltages to decrease the amount of BER degradation. For this task, the adjustment of the offset may be performed by looking for an optimum BER. FIG. 6 illustrates introducing a positive offset to decrease the decision threshold level.

The characteristics of the laser portion of the system may be optimized by defining an optimal BER, adaptively changing the laser output power parameter L, and adjusting the Extinction Ratio (ER). ER is defined from histogram measurements as ER=μ₁/μ₀. Cooled Transmitter Optical Sub-Assembly (TOSA) is commonly used for 10 Gbps long reach applications. TOSA consists of a DFB CW source optically coupled to a monitoring diode that is monolithically integrated with Electro Absorption Modulator (EAM), as it is shown in FIG. 1. High frequency signals carrying 10 Gps traffic are applied to the EAM input using commercially available EAM drivers with integrated bias circuitry. The last one is used to change modulation and ER of the optical signal as well as average output power L.

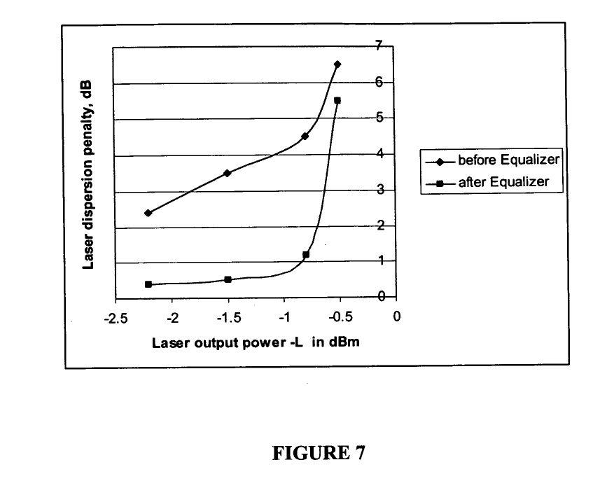

FIG. 7 illustrates the mechanism of optimization of laser characteristics. The upper curve shows laser dispersion penalty versus laser output power L before the Equalizer stage and the lower curve shows the same characteristic after the Equalizer stage. Usually, in such TOSA transmitters, the increase of L causes a rapid increase of a dispersion penalty, represented by the upper line in FIG. 7. If the compensation of the dispersion penalty in the system takes place, the equalizer block can compensate for the dispersion penalty in the field where the value of the dispersion penalty does not exceed the equalizer circuit specification limits. The compensated dependence is shown in FIG. 7 by the lower line. The system power budget can be defined as the sum of two main contributions—receiver sensitivity (−30 dBm) and the laser output power minus the dispersion penalty:
Power budget=−30 dBm+L−dispersion penalty [equation (4)]

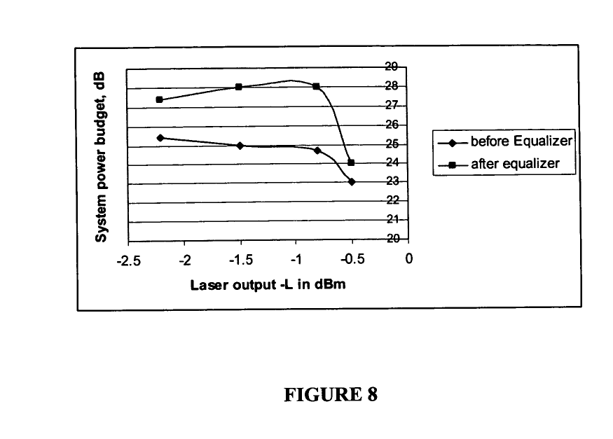

The power budget curves for cases before and after the equalizer stage are shown in FIG. 8. The case “after Equalizer” has clear local maximum. This fact can be used for adaptive optimization of L parameter value.

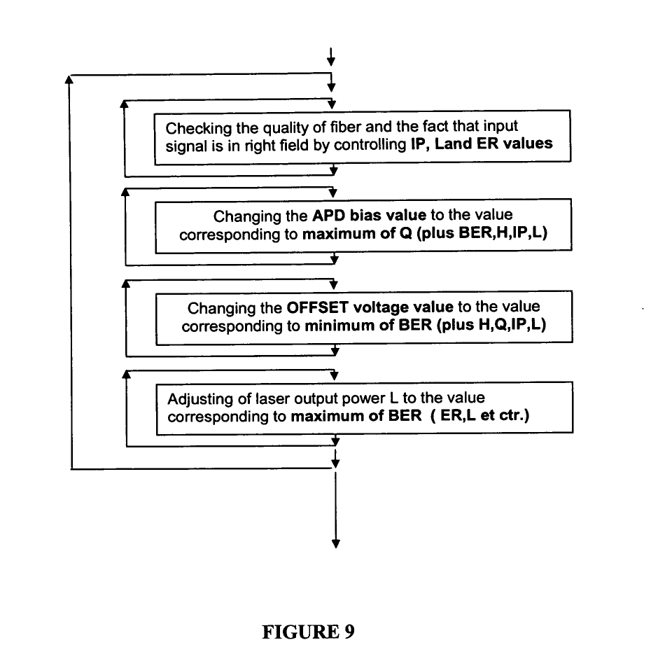

In one embodiment, the adaptive adjustment of each portion of the system does not affect or substantially affect other portions of the system and can be done individually based on a predetermined or selected priority. The adjustment of each portion may be independent of the other portions of the system. For the optical network system, the optimization and the priority of different portions may be assigned based on network channel architecture. FIG. 9 illustrates an exemplary embodiment of a task flow for whole receiver system adaptive adjustment.

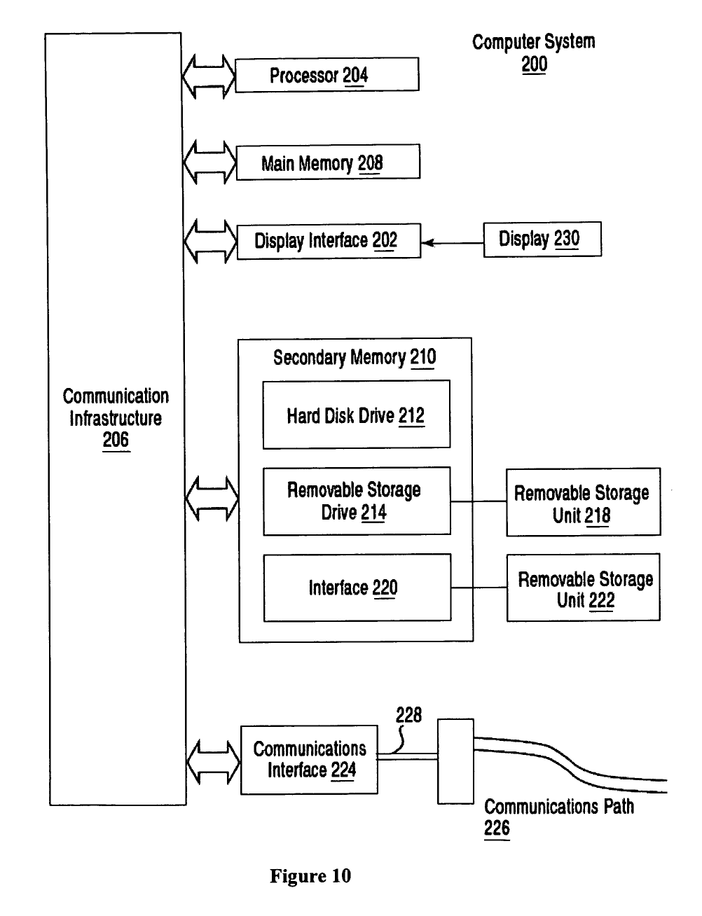

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 10.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Example embodiments of the present invention have now been described in accordance with the above advantages. It will be appreciated that these examples are merely illustrative of the invention. Many variations and modifications will be apparent to those skilled in the art.

What is claimed is:

1. A method of adaptively adjusting an Avalanche photo-diode (APD) optical receiver and laser system, the method comprising:
determining a value for at least one of a Q-factor, an optimal Bit Error Rate (BER), an intensity level “1” and “0”; an input optical power, and a laser output power; and
adjusting at least one parameter from the group consisting of the Q-factor, the optimal BER, the intensity of level “1” and “0”; the input optical power, and the laser output power.

2. The method of claim 1, further comprising dividing the system into separate portions and adjusting each portion independently of the other portions of the system.

3. The method of claim 2, further comprising determining a priority to be assigned to a portion of the system based on network channel architecture; and adjusting each portion in an order based on the priority of the portion.

4. An Avalanche photo-diode optical receiver and laser system comprising:
an APD portion;
a laser portion; and
a processor portion,
wherein the system is configured to adjust at least one portion of the system through controlling at least one parameter from the group consisting of a Q-factor, an optimal Bit Error Rate, an intensity for level “1” and “0”; an input optical power, and a laser output power.
